(19) United States
(12) Patent Application Publication
(10) Pub. No.: US 2002/0132160 A1
(43) Pub. Date: Sep. 19, 2002

(54) Battery

(75) Inventor: Yukio Ehara, Kyoto-shi (JP)

Correspondence Address: SUGHRUE MION, PLLC, 2100 PENNSYLVANIA AVENUE, N.W., WASHINGTON, DC, 20037, US

(73) Assignee: GS-MELCOTEC CO. LTD.

(21) Appl. No.: 10/098,378

(22) Filed: Mar. 18, 2002

(30) Foreign Application Priority Data
Mar. 19, 2001 (JP) P. 2001-78600

(51) Int. Cl. H01M 2/08; H01M 2/04

(52) U.S. Cl. 429/53; 429/175; 429/56

(57) ABSTRACT

The invention lies in a battery comprising a battery container closed at one end thereof, an electric-generating element received in the battery container, and a cover body covering the opening of the battery container. The cover body has an indented portion formed on the outer side thereof extending inward and a valve disposed on the inner wall of the indented portion for releasing the inner pressure of the battery. The battery of the invention comprises a valve disposed on the deep side of the indented portion for releasing the inner pressure of the battery. In this arrangement, any foreign matters which hit the area of the cover body close to the indented portion cannot enter into the indented portion. Even foreign matters which could have entered into the indented portion, it is difficult to reach the side wall of the indented portion. Accordingly, it is less likely that foreign matters can come in direct contact with the valve. This can prevent the valve from being opened by accident to cause the leakage of electrolyte during handling of the battery.

### FIELD OF THE INVENTION

The present invention relates to a battery provided with a valve for releasing the inner pressure thereof when it shows an abnormal rise as in non-aqueous electrolyte secondary battery or the like.

### BACKGROUND OF THE INVENTION

An example of the conventional structure of a thin prismatic non-aqueous electrolyte secondary battery is shown in FIGS. 4 and 5. This non-aqueous electrolyte secondary battery comprises an ellipsoidal spirally wound electricity-generating element 2 received in a thin prismatic outer case 1 made of an aluminum alloy. The outer case 1 comprises a prismatic battery container 1a and a cover body 1b welded to cover the upper opening of the battery container 1a. The electricity-generating element 2 is formed by ellipsoidally winding a positive electrode 2a having a mixture with a positive active material supported on a belt-shaped aluminum foil and a negative electrode 2b having a mixture with a negative active material supported on a belt-shaped copper foil with a separator 2c provided interposed therebetween. The copper foil drawn from the outermost negative electrode 2b of the coil is connected and fixed to a negative current collector connector 4 disposed on the lower surface of the cover body 1b with an insulating material 3 interposed therebetween so that it is connected to a negative electrode terminal 5 mounted on the cover body 1b. The negative electrode terminal 5 is disposed at the central portion on the upper surface of the cover body 1b with a packing 6 interposed therebetween. The protrusion extending downward passes through the cover body 1b and is caulked on the negative current collector connector 4 with the insulating material 3 interposed therebetween to make sealed connection. The aluminum foil drawn from the outermost positive electrode 2a of the coil is connected and fixed to a positive current collector 7 directly connected and fixed to the lower surface of the cover body 1b so that the cover body 1b and the battery container 1a act as positive electrode terminal themselves.

Since the inner pressure of the outer case 1 rises during overcharging, the non-aqueous electrolyte secondary battery comprises a thin portion formed integrally to the cover body 1b to form a valve 8 which breaks to release the inner pressure of the battery. In some detail, the valve 8 is an ellipsoidal groove 8a formed on the aluminum alloy plate of the cover body 1b to a thickness such that it does not reach the lower surface of the cover body 1b as shown in FIG. 6. In this arrangement, when the inner pressure of the battery rises beyond a predetermined value, the thin portion of the valve 8 formed by the groove 8a breaks due to the inner pressure, making it possible to release the inner high pressure.

However, the valve 8 is formed by forming the groove 8a on the cover body 1b to obtain a thin portion and thus is weak to external impact. Accordingly, the conventional non-aqueous electrolyte secondary batteries are disadvantageous in that the valve 8 breaks to cause the leakage of inner non-aqueous electrolyte even when protrusions hit the cover body 1b or foreign matters come in contact with the cover body 1b during the handling of the battery in production or use.

### SUMMARY OF THE INVENTION

The invention has been worked out to cope with the above-mentioned circumstances. An aim of the invention is to provide a battery which undergoes no electrolyte leakage due to contact by foreign matters.

The invention lies in a battery comprising a battery container closed at one end thereof, an electric-generating element received in the battery container, and a cover body covering the opening of the battery container. The cover body has an indented portion formed on the outer side thereof extending inward and a valve disposed on the inner wall of the indented portion for releasing the inner pressure of the battery.

The battery of the invention comprises a valve disposed on the deep side of the indented portion for releasing the inner pressure of the battery. In this arrangement, any foreign matters which hit the area of the cover body close to the indented portion cannot enter into the indented portion. Even foreign matters which could have entered into the indented portion, it is difficult to reach the side wall of the indented portion. Accordingly, it is less likely that foreign matters can come in direct contact with the valve. This can prevent the valve from being opened by accident to cause the leakage of electrolyte during handling of the battery.

Further, the side wall of the indented portion is preferably formed almost perpendicular to the surface of the cover body. In the arrangement such that a valve is disposed on the vertical inner side wall of the indented portion, any foreign matters which have entered in the indented portion cannot hit the side wall of the indented portion but drop straightly downward to hit the bottom of the indented portion unless they move obliquely. This makes it less likely that the foreign matters can come in contact with the valve.

The foregoing valve preferably comprises a thin portion formed integrally to the cover body so that when the thin portion breaks, the inner pressure of the battery is released. In this arrangement, a valve having a simple structure can be used. Thus, such a valve can be easily disposed even on the inner side wall of the indented portion.

Further, the foregoing valve preferably operates when the inner pressure of the battery reaches 3.04×10⁵ Pa or higher. In this arrangement, a valve which operates when the inner pressure of the battery reaches 3.04×10⁵ Pa or higher is disposed on the inner side wall of the indented portion, making it possible to provide a safety device most suitable particularly for non-aqueous electrolyte secondary battery, etc.

### BRIEF DESCRIPTION OF THE DRAWINGS

FIG. 1 is a partial perspective view of an embodiment of implication of the invention illustrating the area in the vicinity of the cover body of the outer case of a non-aqueous electrolyte secondary battery;

FIG. 2 is a partial longitudinal side section of the embodiment of implication of the invention illustrating the area in the vicinity of the indented portion on the cover body of the outer case of a non-aqueous electrolyte secondary battery;

FIG. 3A is a sectional view illustrating a process for the production of a valve;

FIG. 3B is a sectional view illustrating a process for the production of a valve;

FIG. 4 is an exploded perspective view of a related art illustrating the structure of a non-aqueous electrolyte secondary battery;

FIG. 5 is a longitudinal side section of a related art illustrating the structure of a non-aqueous electrolyte secondary battery; and

FIG. 6 is a partial longitudinal side section of a related art illustrating the area in the vicinity of the valve on the cover body of the outer case of a non-aqueous electrolyte secondary battery.

### DETAILED DESCRIPTION OF THE INVENTION

An embodiment of implication of the invention will be described hereinafter in connection with the attached drawings, but the present invention is not construed as being limited thereto.

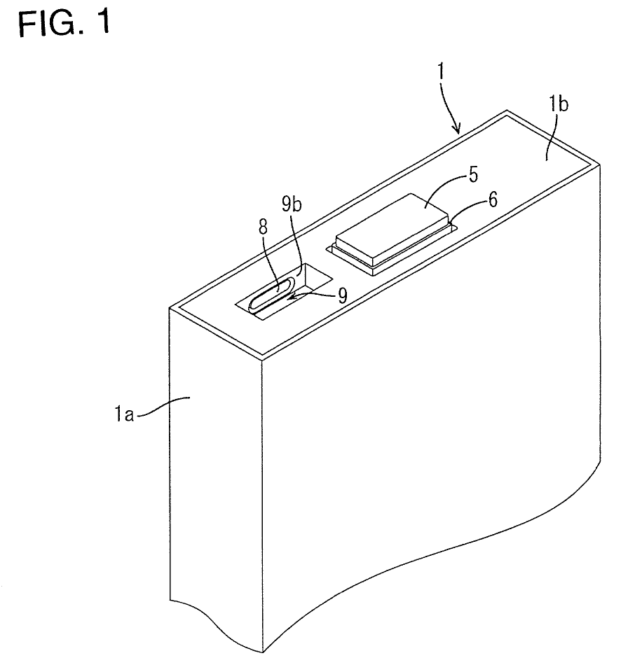

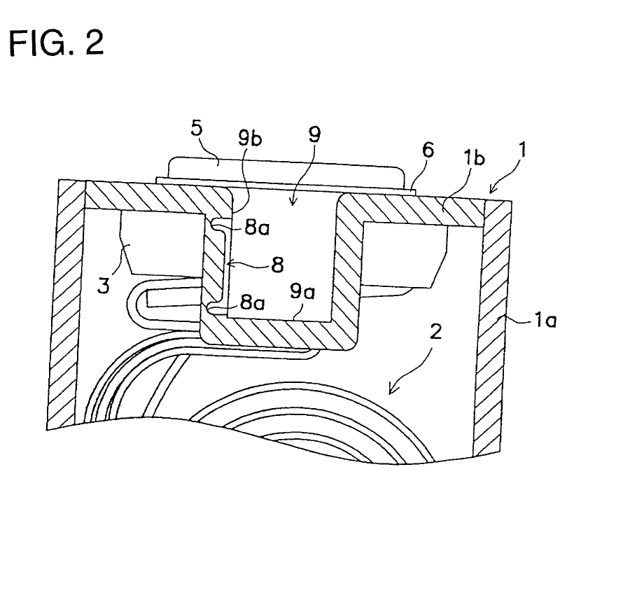

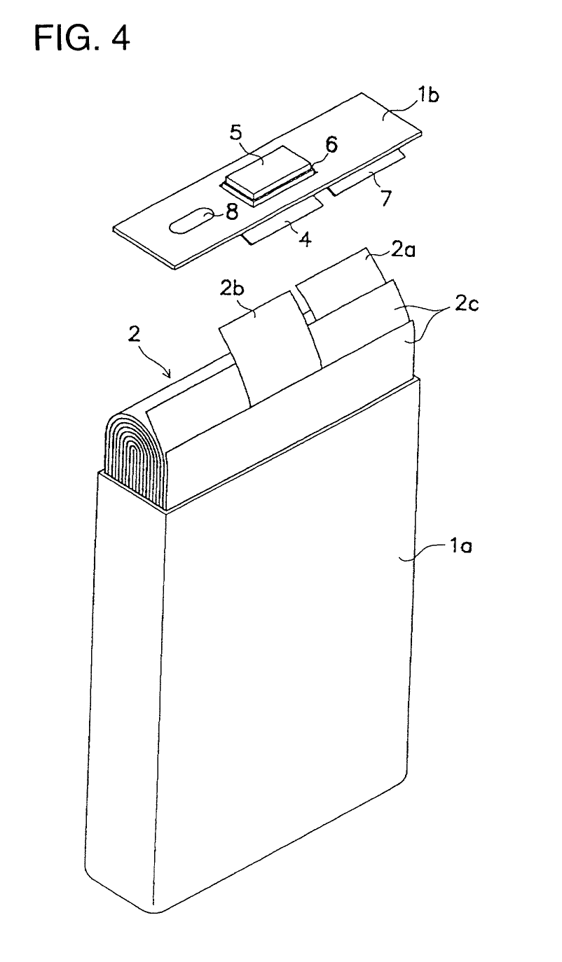

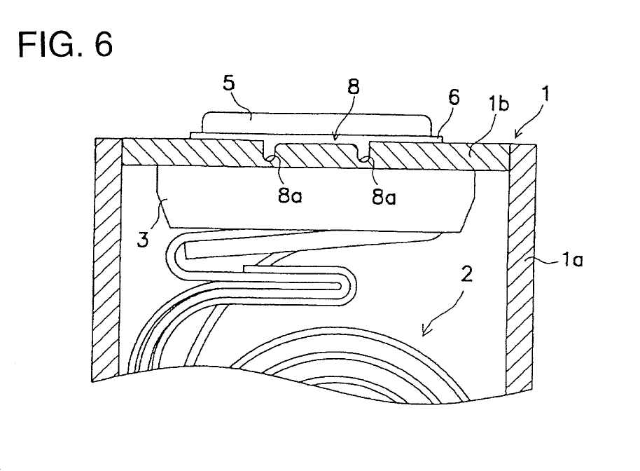

FIGS. 1 and 2 each illustrate an embodiment of implication of the invention. FIG. 1 is a partial perspective view of an embodiment of implication of the invention illustrating the area in the vicinity of the cover body of the outer case of a non-aqueous electrolyte secondary battery, and FIG. 2 is a partial longitudinal side section of the embodiment of implication of the invention illustrating the area in the vicinity of the indented portion on the cover body of the outer case of a non-aqueous electrolyte secondary battery. Where the constituent members function in the same way as those of the related art of FIGS. 4 to 6, the same reference numerals are used in FIGS. 1 and 2.

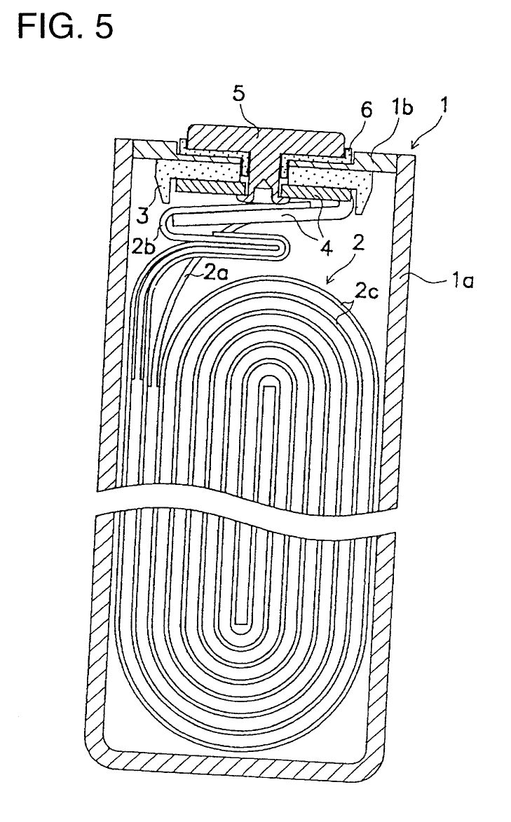

The present embodiment of implication of the invention is a thin prismatic non-aqueous electrolyte secondary battery similar to the related art. The configuration of the battery container la and the electricity-generating element 2 of the outer case 1 are the same as that of the related art shown in FIGS. 4 and 5. The cover body 1b is formed by a slender rectangular aluminum alloy similar to the related art. The negative electrode terminal 5, the negative current collector connector 4 and the positive current collector connector 7 are mounted in the battery similarly to the related art.

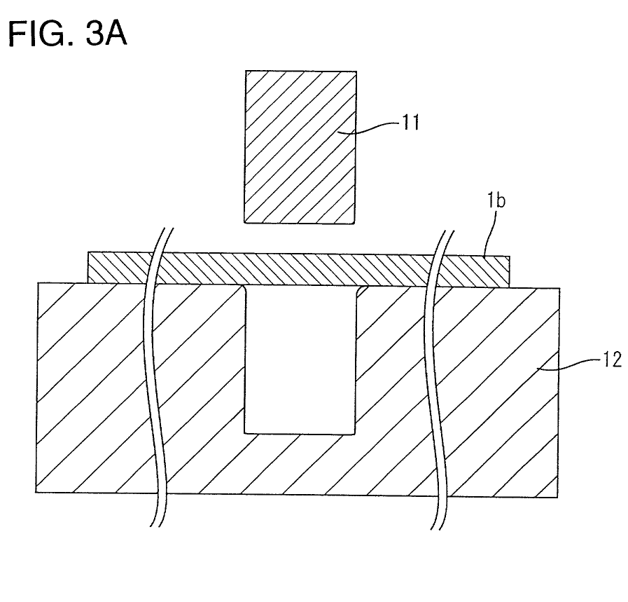

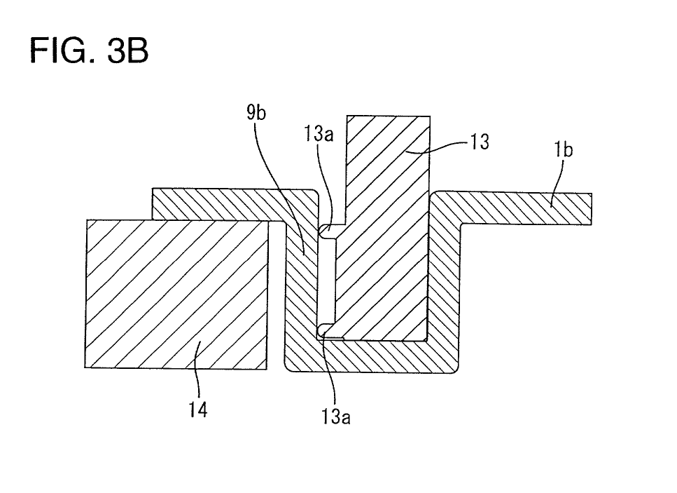

The foregoing cover body 1b has an indented portion 9 formed on one side of the central negative terminal 5 extending downward from the upper surface thereof as shown in FIGS. 1 and 2. For example the indented portion 9 is formed by pressing the cover body 1b against a die by a press mold 11, 12 into a box form. The intended portion 9 comprises a rectangular bottom plate 9a and a side wall 9b extending vertically upward from the four sides of the bottom plate 9a and connected to the flat portion of the cover body 1b at the upper end thereof as shown in FIG. 3A. However, the indented portion 9 is not necessarily needed to be formed integrally to the cover body 1b but may be formed by fixing a box formed by an aluminum alloy plate to the lower surface of the cover body 1b having a rectangular hole formed therein at the area of the rectangular hole.

The foregoing indented portion 9 has a valve 8 formed on one of the four side walls 9b thereof for releasing the inner pressure of the battery when its thin portion breaks. The valve 8 is an ellipsoidal closed loop groove 8a formed in the aluminum alloy plate of the side wall 9b extending from the inner side of the indented portion 9 to a thickness such that it does not reach the opposite side similarly to the related art. The groove 8a is formed by pressing the outer side wall 9b of the indented portion by a mold 14 which moves rightward as viewed on the drawing with a mold 13 having a closed loop raised portion 13a pressed against the inner side wall 9b of the intended portion 9 to a thickness such that it does not reach the outer side of the indented portion 9 as shown in FIG. 3B.

The valve 8 is arranged so as to operate when the inner pressure of the battery reaches 3.04×10⁵ Pa or higher. In this arrangement, the valve 8 can make an optimum operation to provide the non-aqueous electrolyte secondary battery with maintained safety. The shape of the groove 8a is not necessarily needed to be endless form such as ellipsoid or circle but may be straight line or curved line or two crossing lines. Instead of forming such a groove 8a, the thickness of the plate of the side wall of the indented portion may be reduced over a predetermined range to form the valve 8.

In the non-aqueous electrolyte secondary battery having the foregoing structure, when the inner pressure of the outer case 1 rises beyond a predetermined value due to overcharging, it presses the inner surface of the battery case la or the lower surface of the cover body 1b as well as the bottom plate 9a and side wall 9b of the indented portion 9. As a result, the indented portion breaks at the thin portion of the side wall 9b of the valve 8 formed by the groove 8a due to the inner pressure of the outer case 1, making it possible to release the high inner pressure of the outer case 1. Further, when the valve 8 bursts since the high pressure gas bursts forth and hits the other side wall 9b of the indented portion 9 before being released upward and discharged, the bursting power of the high pressure gas can be reduced.

Accordingly, in accordance with the present embodiment of implication of the invention, the valve 8 is formed on the side wall 9b of the indented portion 9 of the cover body 1b, making it possible to prevent even foreign matters such as external protrusion which have hit the non-aqueous electrolyte secondary battery from entering in the indented portion 9. Thus, these foreign matters can be blocked at the area close to the opening of the indented portion 9. Further, even any foreign protrusions which have entered in the indented portion 9 can mostly move straightly downward and hit the bottom plate 9a and thus can be prevented from coming in contact with the valve 8 on the side wall 9b. In this arrangement, the valve 8 can be prevented from breaking by accident to cause the leakage of electrolyte even when the battery hits something or drops during the handling of non-aqueous electrolyte secondary battery at the production step or setting for use.

While the present embodiment has been described with reference to the case where the valve 8 is formed by forming a groove 8a on the side wall 9b of the indented portion 9 to reduce the thickness of the side wall 9b, through-holes which have been formed in the side wall 9b may be covered by a thin material such as metal foil which can break at a predetermined pressure or higher. Alternatively, the valve may be arranged such that a material sealed in the opening of the through-holes can be peeled off at a predetermined pressure or higher. Further, such a valve 8 may be replaced by any other valve which can release the inner pressure of the battery when the inner pressure of the battery reaches a predetermined pressure or higher. For example, the opening of the through-holes formed on the side wall 9b may be plugged with a valve which is then energized toward the opening of the through-hole against the inner pressure by the elasticity of a rubber, plate spring or diaphragm.

While the present embodiment of implication of the invention has been described with reference to the case where the battery container 1a and the cover body 1b of the outer case 1 are formed by an aluminum alloy, they may be made of other metal such as stainless steel, plastic or the like.

While the present embodiment of implication of the invention has been described with reference to the case where the indented portion 9 is in the form of rectangular box, it may be in the form of long cylinder or other indentation form. However, when the indented portion 9 is circular or ellipsoidal, the side wall 9b of the indented portion 9 is entirely formed by a curved surface, making it difficult to work the side wall 9b into a valve 8. Further, the side wall 9b does not necessarily cross the surface of the outer case 1 in the vicinity of the indented portion at right angle but may be inclined to the surface of the outer case 1. In this case, when the side wall 9b is inclined such that the bottom plate 9a is wider than the opening of the indented portion, it is surely less likely that foreign matters can come in contact with the valve 8 of the side wall 9b. On the contrary, when the side wall 9b is inclined such that the bottom plate 9a is narrower than the opening of the indented portion 9, it is more likely that foreign matters which have entered in the indented portion 9 can come in contact with the valve 8 of the side wall 9b. However, most of these foreign matters can be prevented from entering in the indented portion beyond the opening thereof, making it possible to protect sufficiently the valve 8 as compared with the related art. Alternatively, by inclining the side wall 9b to form an indented portion 9 having an form of inverted cone, the bottom plate 9a can be eliminated. Further, by bending the side wall 9b into a semi-sphere, the bottom plate 9a can be eliminated. In the case where no bottom plate 9a is present, the interior of the indented portion 9 is entirely formed by the side wall 9b.

While the present embodiment of implication of the invention has been described with reference to a thin prismatic non-aqueous electrolyte secondary battery, the size and shape of the outer case 1 are arbitrary. The invention may be implemented for any kinds of batteries requiring that the outer case 1 be provided with a valve.

As can be seen in the foregoing description, the battery of the invention comprises a valve disposed on the deep side wall of an indented portion formed on the cover body 1b, making it possible to prevent the valve from being opened by accident to cause the leakage of electrolyte during the handling of the battery.

While the invention has been described in detail and with reference to specific embodiments thereof, it will be apparent to one skilled in the art that various changes and modifications can be made therein without departing from the scope thereof.

This application is based on Japanese patent application No. 2001-078600 filed Mar. 19, 2001, the entire contents thereof being hereby incorporated by reference.

What is claimed is:

1. A battery comprising:
a battery container closed at one end thereof;
an electric-generating element received in said battery container; and
a cover body covering the opening of said battery container, wherein
said cover body has an indented portion formed on the outer side thereof extending inward and a valve disposed on the inner wall of said indented portion for releasing the inner pressure of said battery.

2. The battery according to claim 1, wherein the inner wall of said indented portion is formed almost perpendicular to the surface of said cover body.

3. The battery according to claim 1, wherein said valve comprises a thin portion formed integrally to said cover body so that when the thin portion breaks, the inner pressure of the battery is released.

4. The battery according to claim 2, wherein said valve comprises a thin portion formed integrally to said cover body so that when the thin portion breaks, the inner pressure of the battery is released.

5. The battery according to claim 3, wherein said thin portion is a closed loop groove formed on the inner wall of said indented portion to a thickness such that the groove does not reach the outer side of said indented portion.

6. The battery according to claim 4, wherein said thin portion is a closed loop groove formed on the inner wall of said indented portion to a thickness such that the groove does not reach the outer side of said indented portion.

7. The battery according to claim 1, wherein said valve operates when the inner pressure of said battery reaches 3.04×10⁵ Pa or higher.

8. The battery according to claim 2, wherein said valve operates when the inner pressure of said battery reaches 3.04×10⁵ Pa or higher.

9. The battery according to claim 3, wherein said valve operates when the inner pressure of said battery reaches 3.04×10⁵ Pa or higher.

10. The battery according to claim 4, wherein said valve operates when the inner pressure of said battery reaches 3.04×10⁵ Pa or higher.

11. The battery according to claim 5, wherein said valve operates when the inner pressure of said battery reaches 3.04×10⁵ Pa or higher.

12. The battery according to claim 6, wherein said valve operates when the inner pressure of said battery reaches 3.04×10⁵ Pa or higher.

13. The battery according to claim 5, wherein said thin portion is formed by pressing said cover body to form said indented portion on the surface thereof, and then pressing the outer side wall of said indented portion by a mobile mold with a mold having a closed loop raised portion in contact with the inner side of said intended portion.

14. The battery according to claim 6, wherein said thin portion is formed by pressing said cover body to form said indented portion on the surface thereof, and then pressing the outer side wall of said indented portion by a mobile mold with a mold having a closed loop raised portion pressed against the inner side of said intended portion.

15. The battery according to claim 11, wherein said thin portion is formed by pressing said cover body to form said indented portion on the surface thereof, and then pressing the outer side wall of said indented portion by a mobile mold with a mold having a closed loop raised portion pressed against the inner side of said intended portion.

16. The battery according to claim 12, wherein said thin portion is formed by pressing said cover body to form said indented portion on the surface thereof, and then pressing the outer side wall of said indented portion by a mobile mold with a mold having a closed loop raised portion pressed against the inner side of said intended portion.
